(19) United States
(12) Patent Application Publication
(10) Pub. No.: US 2005/0000253 A1
(43) Pub. Date: Jan. 6, 2005

(54) Method of manufacture of low water peak single mode optical fiber

(76) Inventors: Kang Xie, Wuhan (CN); Shuqiang Zhang, Wuhan (CN); Qingrong Han, Wuhan (CN); Tiejun Wang, Wuhan (CN); Chenghou Tu, Wuhan (CN); Raji Matai, Wuhan (CN)

Correspondence Address: Min (Amy) S. Xu, Esq.;DORSEY & WHITNEY LLP, Intellectual Property Department, 50 South Sixth Street, Suite 1500, Minneapolis, MN, 55402-1498, US

(21) Appl. No.: 10/874,456

(22) Filed: Jun. 23, 2004

(30) Foreign Application Priority Data
Jun. 27, 2003 (CN) 03128228.8

(51) Int. Cl. C03B 37/018

(52) U.S. Cl. 65/417; 65/419

(57) ABSTRACT

The present invention directs to a method of manufacturing low water peak single mode optical fiber, which comprises performing deposition in a substrate tube using PCVD technology, whereby a deposited layer of a certain construction design is formed on the inner wall of the substrate tube, melt contracting the substrate tube into a solid core rod according to melt contraction technology, producing an optical fiber preform by combining the core rod and a jacket tube of low hydroxyl content by means of RIT technology or by depositing an outer cladding on the outer surface of the core rod using OVD technology, sending the optical fiber preform into a fiber drawing furnace to draw it into an optical fiber, wherein: in the PCVD technology, the content of impurities in a gas mixture of raw materials, which is characterized by the infrared spectrum transmissivity thereof, is required to a transmissivity of 90% or greater, the water content in O₂ is 100 ppb or less, the water content in C₂F₆ is 1000 ppb or less, the hydroxyl content of the substrate tube is 1000 ppb or less, the dynamic leak rate of a deposition machine is 1.0×10⁻⁵ mbar·l/s or less; during melt contraction of the substrate tube, the dynamic leak rate of a melt contraction machine is 1.0×10⁻⁵ mbar·l/s or less; the hydroxyl content of the jacket tube of low hydroxyl content is required to be 10 ppm or less; the relative humidity of environment during the process of manufacture is 25% or less; the ratio of the cladding diameter to the core layer diameter (b/a value) in the waveguide structure of the optical fiber is from 2.0 to 7.0.

### CROSS-REFERENCE TO RELATED APPLICATION(S)

The present application claims priority to Chinese Patent Application No. 03128228.8, filed on Jun. 27, 2003, the contents of which is incorporated by reference herein in its entirety.

### TECHNICAL FIELD

The present invention relates to a method of reducing the hydroxyl content of optical fiber preform for the manufacture of low water peak single mode fiber, in particular, a method of manufacture of low water peak single mode optical fiber at low cost in which an optical fiber preform is produced by means of plasma chemical vapor deposition with adjusting process parameters and controlling raw material and environmental factors.

### TECHNICAL BACKGROUND

With the rapid growth of traffic of communication information, the size of optical network of wavelength division multiplexing (WDM) technique and transmission capacity are continuously increasing. WDM systems are capable of simultaneously transmitting optical carrier waves of various wavelengths with sufficient separation between each other and arranging them in sequence. Each optical carrier wave is modulated by digital signal, whereby a plurality of different digital signals are transmitted along a single fiber at the same time. It is evident that the wider the range of optical wave used for communication, the greater the transmission capacity.

During optical fiber transmission, the wavelength that can be used by WDM is limited to the window of 1310 nm and 1550 nm due to the existence of absorption peaks in the range of 1360-1460 nm of hydroxyl groups. Therefore, in order to use fiber in full wave band including the extended wave band of 1360-1460 nm, it is necessary to eliminate the effect of water peaks in the wave band. Such fibers can provide a useful band as wide as 400 nm. According to ITU-T G. 652.C/D Standard, when its attenuation within the range 1383±3 nm is less than the stipulated value at 1310 nm, the optical fiber is generally called “low water peak fiber” or “zero water peak fiber”.

The low water peak fiber is especially suitable for the establishment of metropolitan area network, wherein O-band (1260-1360 nm) can be used for WDM to simulate video; multiwave-band data transmission of high bit rate (10 Gb/s) may be accomplished in E-band (1360-1460 nm); dense wave division multiplex (DWDM) transmission at 2.5 Gb/s can be opened up in S, C, L-bands (1460-1625 nm). The use of this fiber system may have many advantages; (1) the number of wavelengths that can be multiplexed is greatly increased, (2) different transaction can be allocated to a transmitting wavelength most suitable for the transmission to improve the network management; (3) coarse wavelength division multiplexing and inexpensive components can be used, thus the cost of the whole system is reduced.

Optical fiber is produced by drawing of an optical fiber preform at high temperature. There are four typical methods for the preparation of optical fiber preforms: modified chemical vapor deposition (MCVD), plasma chemical vapor deposition (PCVD), outside vapor deposition (OVD), and vapor phase axial deposition (VAD). The PCVD method for preparation of optical fiber preform described in U.S. Pat. No. 4,292,063 is suitable for making fiber for transmission at 1310 nm and 1550 nm communication window. However, it is difficult to remove hydroxyl groups in the preform by the described method. The published Chinese. Patent Application 98813827.1 describes an improved PCVD apparatus and method for preparation of preforms, but it does not solve the problem of high attenuation caused by the water peaks of fiber yet. The PCT application WO01/05721A1 describes a technology for melt-contracting, i.e., collapsing, PCVD core rod using electroheating elements instead of oxyhydrogen flame. Using this technology, the content of hydroxyl group on the surface of melt-contracted preform can be reduced from about 1000 ppm to less than 10 ppm. This method, however, has not disclosed the water peak attenuation value of the optical fiber after drawing.

A typical PCVD technology for the production of optical fiber is as follows. A substrate tube is placed in a resonant cavity along its cylindrical axis, and a mixture of raw material gases containing for example, O₂, SiCl₄, GeCl₄ and the like is passed into the tube; a local plasma is simultaneously produced within the resonant cavity, causing the reaction of Si, Ge, O, etc., thereby SiOₓ mainly doped with Ge is formed by direct deposition on the inside surface in the substrate tube, forming a core layer and partial cladding layer. The resonant cavity moves to and fro along the cylindrical axis of the substrate tube as to uniformly coat its whole length. When deposition is finished the substrate tube is collapsed into a solid core rod, which has a SiO₂ core layer highly doped with Ge and a surrounding SiO₂ cladding undoped or doped with F—Ge. Such a core rod is made into an optical fiber preform by inserting into a jacket tube or by OVD overcladding, which can be drawn into optical fiber used as the transmission medium for communication.

The OVD and VAD technologies for the production of low water peak optical fiber are reported currently, but OVD and VAD technology are substantially different from PCVD, thus the same technical approach can not be used. Generally, OVD and VAD technologies employ oxyhydrogen flame as reaction heat source. The typical reaction is as follows.
SiCl₄+2H₂O→SiO₂+4HCl
GeCl₄+2H₂O→GeO₂+4HCl (1)

The SiO₂ obtained exists in the form of soot, in which considerable quantities of water in various forms (e.g., water molecules, hydroxyl groups) is adhered and contained due to the production of water by burning the oxyhydrogen gas. The effort to eliminate water peak has been concentrated on removing water with dehydrating agents.

PCVD method, however, uses microwave as the energy source directly activating reactants to react in an environment without water, wherein the reaction is as follows.
2SiCl₄+xO₂→2SiOₓ+4Cl₂
2GeCl₄+xO₂→2GeOₓ+4Cl₂ (2)

Because the reaction here is carried out in an enclosed container under a negative pressure, the effort to eliminate water peak with PCVD technology is to focus on decreasing and even eliminating the water carried by the raw materials themselves, preventing external moisture from coming into the reaction zone, removing the water formed by reaction, etc. Moreover, the fiber performance can be further optimized by the characteristics of PCVD technology.

There have not been found published literatures on producing low water peak optical fiber by means of PCVD technology.

Definition of Some Terms and Their Description

“Substrate tube”: the tube made of highly pure quartz glass for inside vapor deposition, with solid products deposited on the inner wall of the glass tube after reaction.

“Core rod”: preform comprising core layer and partial cladding.

“Refractivity index profile”: the relationship of the refractivity of optical fiber or optical fiber preform (including core rod) glass versus its radius.

“Jacket tube”: thick-walled highly pure quartz glass tube satisfying a certain cross-section requirement.

“RIT technology”: The manufacture technology of assembling optical fiber preform by inserting core rod into jacket tube.

“OVD (Outside Vapor Deposition) technology”: The deposition of SiO₂ glass of a desired thickness on the surface of core rod by the vapor deposition.

“b/a value”: defined as the ratio of the depressed cladding diameter deposited within the tube to the core layer diameter, as detailed in FIG. 4 and FIG. 6.

“Oxygen-silicon ratio (O/Si ratio): defined as the ratio of the whole oxygen introduced into the substrate tube during deposition to the total amount of SiCl₄ and GeCl₄.

“Relative refractivity”:

$$Δ \% = [ \frac{( {n}_{1}^{2} - {n}_{0}^{2} )}{2 {n}_{1}^{2}} ] \times 100 \% ,$$

wherein n and n₀ represent the relative refractivity of the two glass materials respectively.

“Refractivity difference Δ+”: as shown in the above expression, it is defined when n₁ is the refractivity of core layer and no is the refractivity of pure silica glass.

“Refractivity difference Δ−”: as shown in the above expression, it is defined when n₁ is the refractivity of depressed cladding and no is the refractivity of pure silica glass.

### SUMMARY OF INVENTION

The technical problem to be solved by the present invention is to provide a preparation method for low water peak single mode optical fibers by improving the traditional PCVD technology, the attenuation of the single mode optical fiber produced thereby at 1383 nm being lower than the specified value at 1310 nm.

The technical approach employed for solving the problems proposed above by the present invention is as follows: Deposition is performed in a substrate tube using PCVD technology, whereby a deposited layer of a certain construction design is formed on the inner wall of the substrate tube. The substrate tube is melt contracted into a solid core rod, and then an optical fiber preform is made by combining the core rod and a jacket tube of low hydroxyl content by means of RIT technology or by depositing an outer cladding on the outer surface of the core rod using OVD technology. After that, the optical fiber preform is sent into a drawing furnace to draw it into an optical fiber. The technical approach is distinguished by the following.

In the PCVD technology used, the content of impurities in the gas mixture of raw materials is characterized by its infrared spectrum transmissivity. It is required that the transmissivity is 90% or greater, the water content in O₂ is 100 ppb or less, the water content in C₂F₆ is 1000 ppb or less, the hydroxyl content in the substrate tube is 1000 ppb or less, the dynamic leak rate of deposition machine is 1.0×10⁻⁵ mbar·l/s or less;

during the melt contraction of substrate tube, the dynamic leak rate of melt contraction machine is 1.0×10⁻⁵ mbar·l/s or less;

the hydroxyl content of the jacket tube of low hydroxyl content is required to be 10 ppm or less;

the relative humidity of environment during the manufacturing is 25% or less;

the ratio of the cladding diameter to the core diameter (b/a value) in the waveguide structure of the optical fiber is from 2.0 to 7.0.

According to the method described above, a mixture of gaseous raw materials taking part in reaction during PCVD comprises SiCl₄, GeCl₄, C₂F₆, and O₂, wherein the content of impurity SiCl₃OH in SiCl₄ characterized by its infrared transmissivity must be a transmissivity of 90%-100%, preferably greater than 95%, more preferably greater than 99%; the content of impurity GeCl₃OH in GeCl₄ characterized by its infrared transmissivity must be a transmissivity of 90%-100%, preferably greater than 95%, more preferably greater than 99%; the water content in C₂F₆ must be 1000 ppb or less, preferably 100 ppb or less, more preferably 10 ppb or less; the O/Si value of the gas mixture of raw materials is 1.5-3.0; the silicon raw material may be other substances not containing hydrogen, such as SiF₄, SiO, Si₃N₄, SiBr₄, (SiO₂).Si(NCO)₄, etc.

During the preparation, the environmental temperature is controlled to be 15-30° C., relative humidity at 25° C. to be 25% or less; preferably 15% or less, more preferably 5% or less, the most preferably being 0%. Such an environment is provided not limited by dry air, as well as dry nitrogen, argon, helium or carbon dioxide or combinations thereof.

In the waveguide structure of optical fiber, the refractivity contribution of freon doped in the cladding is −0.05% to −0.20%, Δ− of the cladding doped with F/Ge is −0.03%˜0.01%; the refractivity contribution of freon doped in the core layer is −0.05% to −0.20%; Δ+ of the core layer doped with F/Ge is 0.30% to 0.40%.

### BRIEF DESCRIPTION OF DRAWINGS

FIG. 1 is a schematic drawing of PCVD technology.

FIG. 2 is a schematic drawing for the cross section of a substrate tube after deposition.

FIG. 3 is a schematic drawing of a solid core rod melt-contracted from the substrate tube after deposition.

FIG. 4 is a schematic drawing for refractivity profile of various fiber preforms (A being the refractivity profile of a Ge doped single mode optical fiber preform, B being the refractivity profile of a F/Ge doped single mode optical fiber preform).

FIG. 5 is a schematic drawing of assembling an optical fiber preform using RIT technology.

FIG. 6 is a schematic drawing for the cross section of an optical fiber prepared according to the present invention.

FIG. 7 is an attenuation spectrum and results of hydrogen loss test of a low water peak optical fiber.

### DETAILED DESCRIPTION OF INVENTION

The following detailed description in combination with the drawings will help to understand the present invention more completely.

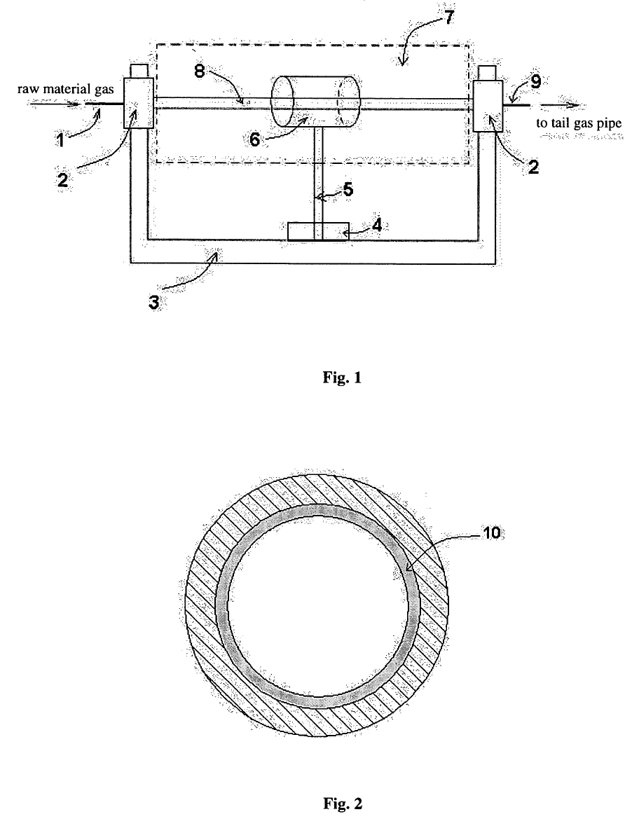

A PCVD deposition machine used in the present invention is shown in FIG. 1. The gaseous mixture of raw materials that are going to take part in reaction containing SiCl₄, GeCl₄, C₂F₆, O₂, etc. is passed through an inlet pipe 1 and a sealed rotating gripping head 2 into a substrate tube 8. The microwave generated by a microwave generator 4 passes through a wave guide 5 into a resonant cavity 6. The resonant cavity 6 is cylindrically symmetrical around its central axis, with the substrate tube 8 passing through it and kept concentric with it. The resonant cavity 6 couples the microwave to the substrate tube 8 to activate the raw material gas to form a local plasma under negative pressure and produce a large quantity of Si., O., SiO., and the like. Reaction products are deposited directly in glass form on the inner wall of the substrate tube. The resonant cavity moves to an fro along the direction of the substrate tube, and a desired amount of deposition layer is deposited on the inner wall of the substrate tube, producing a core layer and partial cladding with a certain refractivity. This reaction is highly effective, with a coefficient of utilization of raw materials approaching 100%. A small amount of tail gas passes through a tail gas pipe 9 into a tail gas absorption apparatus (not shown). Because microwave is coupled directly to the substrate tube, it is not necessary to transfer heat from outside into the reaction, the temperature of furnace 7 is only 1000° C.-1200° C., thereby not only preventing the deformation of substrate tube, but also slowing down the possible diffusion of moisture from outside into the tube. The cross section of the substrate tube after deposition is depicted in FIG. 2. As the thickness of each layer produced by PCVD is extremely small, almost a thousand layers can be deposited, and thus the overall layer 10 deposited can satisfy the requirement for any refractivity profiles.

In the present invention, in view of the fact that desired amounts of various raw materials and their functions are different, their purity requirements are, therefore, different so as to minimize the cost of production while securing the optical fiber quality.

During PCVD, in the gas mixture of raw materials, the water content in O₂ is required to be 100 ppb or less, preferably 10 ppb or less, more preferably 1 ppb or less. In addition to the raw materials, there are also requirements to hydroxyl content of the substrate tube and the jacket tube. It is necessary to select and use substrate tube of extremely low hydroxyl content because the substrate tube directly contacts with the deposited layer and forms a part of cladding. The hydroxyl content of the substrate tube is generally 1000 ppb or less, preferably 100 ppb or less, more preferably 10 ppb or less. In order to reduce the diffusion of hydroxyl group in the material of jacket tube to core layer during fiber drawing, the hydroxyl content of jacket tube is 10 ppm or less, preferably 1 ppm or less, more preferably 100 ppb or less.

In addition, the substrate tube may be subjected to dehydration treatment prior to deposition. It goes in two steps: in the preparation stage, the substrate tube is corroded with hydrofluoric acid (HF), the depth of corrosion being 2-5 μm, followed by drying; in the second stage, O₂ and C₂F₆ are passed into the substrate tube to corrode its inner surface under the action of plasma to eliminate the hydroxyl groups on the inner surface of the substrate tube. In U.S. Pat. No. 4,493,721, this corrosion method using plasma is described.

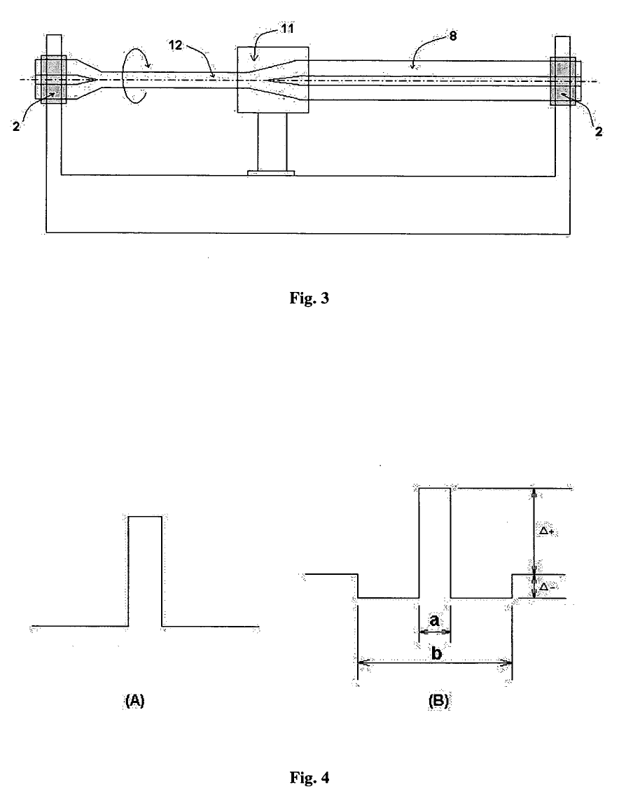

The substrate tube after deposition is melt contracted into a solid core rod. The process is shown schematically in FIG. 3. The deposited substrate tube 8 is placed in a melt contraction machine, the interior of the substrate tube is evacuated by an appropriate vacuum unit, and the substrate tube is gradually softened by heat source 11 and finally melt contracted into a pore-free solid core rod 12. The core rods have different refractivity profiles corresponding to different requirements.

Because the temperature during melt contraction is very high, a large quantity of water and hydrogen molecules will diffuse inward from the outer surface of the substrate tube if a conventional oxyhydrogen flame is used as heat source, thus increasing the hydroxyl (OH) content of the core rod. In the present invention, therefore, the core rod melt contracted by oxyhydrogen flame is further corroded with hydrofluoric acid (HF), removing the glass portion rich in hydroxyl group on the surface of core rod with the corrosion depth being 0.5-1.5 mm.

In order to further reduce the hydroxyl content of the core rod, in the present invention, a “non-water” heat source is used. For example, an electroheating apparatus is used as the heat source for melt contraction processing. The electroheating apparatus may be a graphite electric furnace, which can reduce the hydroxyl content on the outer surface of core rod from 1000 ppm to 10 ppm or less, and thus accordingly reduce the hydroxyl content of core layer. A plasma containing no water may also be used as heat source. The obtained core rod then is corroded with HF with corrosion depth of 0.1-1.0 mm.

The core rod 12 and the jacket tube 13 of low hydroxyl content are combined together by RIT technology (as shown in FIG. 5). The optical fiber preform obtained is directly sent into a fiber drawing furnace to be softened and drawn into optical fiber. Because of the presence of gap 14, it is necessary to subject the outer surface of core rod 12 and the inner surface of jacket tube 13 to cleaning treatment. During the drawing process, gap 14 must be evacuated to facilitate the melt contraction of the jacket tube and the core rod and to prevent the possible moisture in the gap from diffusing into core layer under the action of high temperature during the drawing. While processing the core rod 12 and the low hydroxyl jacket tube 13 into a conical form, plasma rather than oxyhydrogen flame is used as heat source, so as to minimize the introduction of hydroxyl groups.

When using RIT technology, the core rod 12 and the low hydroxyl jacket tube 13 can be combined and melt contracted into a solid preform for fiber drawing, so as to minimize the possibility of outer surface of core rod 12 and inner surface of jacket tube 13 contacting with outside moisture.

Alternatively, an OVD method can be used to deposit a required amount of pure silica material on the outer surface of core rod 12. In order to reduce the hydroxyl content of outer cladding, chlorine gas or other dehydration agents (e.g., SOCl₂) are used to remove the moisture in outer cladding during sintering process. The method of depositing outer cladding on PCVD core rod by means of OVD has been described in the co-pending Chinese Patent Application CN1337367A.

Deuterium gas (D₂) can be used to treat the substrate tube so as to further reduce the hydroxyl content of optical fiber. Before the beginning of deposition, a mixed gas containing deuterium is passed into substrate tube 8, causing D₂ to penetrate into the inner surface of substrate tube to form a barrier layer rich in deuterium, thus preventing outside hydroxyl group from diffusing inward during the subsequent melt contracting and fiber drawing processes. At high temperature, D₂ can undergo D/H displacement reaction with hydroxyl groups.
2Si—OH+D₂→2Si—OD+H₂ (3)

In the practice of the present invention, a further treatment is to pass a mixed gas containing deuterium into substrate tube 8 to treat the deposited layer 10 when deposition is finished. Based on reaction equation (3), the hydroxyl group introduced with raw material gas or formed by reaction and incorporated into the deposited layer 10 may be displaced to form OD, so that the hydroxyl content is reduced.

In the practice of the present invention, a still further treatment is to pass a mixed gas containing deuterium into substrate tube 8 to take part in reaction process during deposition. The formation of the hydroxyl group is prevented because deuterium combines with oxygen more easily than hydrogen combines with oxygen, the thus obtained deposited layer has an extremely low hydroxyl content.

In the practice of the present invention, a still further treatment is to pass a mixed gas containing deuterium during melt contraction to treat the substrate tube 8. Because melt contraction is carried out at high temperature, the D/H displacement reaction is more rapid and efficient, thus making it possible to more thoroughly reduce the hydroxyl content in core rod.

The mixed gas containing deuterium comprises 1-100%, preferably 1-5% deuterium. The mixed gas containing deuterium also contains one or more gases selected from helium (He), nitrogen (N₂), and argon (Ar). The treatment duration varies from 10 minutes to 10 hours depending on different stages. For treatment of substrate tube before and after deposition, the treatment is preferably 30 minutes to 1 hours, treatment temperature is 500-1100° C., preferably 900-1100° C.

Because the absorption peak of OD bond is around 1.9 μm, and there are no absorption peaks within the communication window of 1.3-1.6 μm, the displacement of OH bond by OD bond can eliminate the water peak at 1383±3 nm and thus open all communication windows.

When the diameter of central hole is contracted to an appropriate size during melt contraction, a mixed gas comprised of O₂ and C₂F₆ is passed into the central hole to corrode it, with the thickness of deposited layer corroded away typically controlled at 0.05-0.20 mm. This, on one hand, eliminates the sagging of refractivity caused by vaporization of dopants, and on the other hand, eliminates the effect of hydroxyl group in the central hole in the core rod.

As an option of the practice of the present invention, chlorine (Cl₂) gas can be passed into the substrate tube 8 during the melt contraction to carry out a synchronous treatment, because Cl₂ can react with hydroxyl group producing HCl, which is dischargable, and thus reducing hydroxyl group content of the core rod.

In the present invention, fluorine is also doped to reduce the hydroxyl content. Among the four methods for producing optical fiber preform, only PCVD can effectively dope freon because of its high volatility. In U.S. Pat. No. 4,468,413 and 4,802,733 a method of doping freon (C₂F₆) in PCVD technology is described. The action of reducing hydroxyl content by freon lies in two aspects. Firstly, freon reacts with hydrogen to produce HF which is dischargable, secondly, freon displaces hydrogen. Both the two aspects reduce the hydroxyl content in the glass body. The corresponding chemical reaction in plasma state is as follows.
H₂O [symbol] H⁺+OH⁻
2O₂+C₂F₆+6H⁺+6e⁻→6HF+2CO₂ (4)

Water molecules are decomposed into highly active ions under the action of microwave and react with freon to produce HF and CO₂, which are both dischargable.

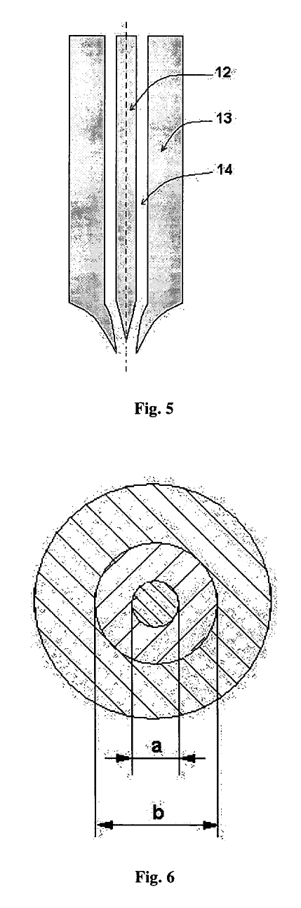

Furthermore, research showed that the increase in the difference between the refractivity of core layer and that of cladding results in reduction of bending attenuation of optical fiber. However, for the optical fiber with its core layer only doped with germanium, although bending attenuation of the fiber can be reduced by increasing the germanium content of the core layer to increase the refractivity difference, the intrinsic attenuation of the optical fiber is increased due to the fact that Rayleigh scattering coefficient of germanium is far greater than that of pure silicon. It is, therefore, difficult to give consideration to the reduction of both transmission attenuation and bending attenuation by simply doping germanium. Because doping glass with fluorine leads to reduction of refractivity of glass, doping the core rod with fluorine leads to reduction of refractivity of the cladding. With the refractivity difference between the core layer and the cladding unchanged, it may correspondingly decrease the refractivity of the core layer thus decreasing the doping content of germanium in the core layer, and thus reduce the intrinsic attenuation of the optical fiber. The refractivity profile of the core rod is shown in FIG. 4(A).

In the present invention, the doping with fluorine causes the core layer and the cladding materials match more in viscosity, reduces the stress in the material and thus reduces Rayleigh scattering of fiber, and at the end reduces effectively the intrinsic attenuation of fiber.

By doping the core layer and the cladding with both F and Ge and by adjusting the amount of doping, the requirement of refractivity can be achieved. After optimization of the technology, the refractivity contribution of freon doped in the cladding is −0.05% to −0.20%, Δ− of the cladding doped with F/Ge is −0.03%˜0.01%; the refractivity contribution of freon doped in the core layer is −0.05% to −0.20%; Δ+ of the core layer doped with F/Ge is 0.30% to 0.40%.

Doping the cladding with fluorine also results in the prevention of diffusion of hydroxyl group from outside to the core layer during melt contracting and fiber drawing processes, which in combination with a proper b/a value will effectively prevent the attack of the core layer by hydroxyl groups from outside and maintain a low hydroxyl state of the core layer. In the present invention, a depressed cladding doped with fluorine is designed with making use of the advantages of PCVD technology, as shown in FIG. 4 (B). When b/a is greater than 2.0, it is sufficient to secure that the hydroxyl groups outside would not diffuse to the core layer. In principle, the larger the b/a value, the more effective the prevention of diffusion of hydroxyl groups, and the corresponding production cost, however, will be raised. Therefore, weighing and balancing the effect of diffusion prevention and production cost, the b/a value is controlled to be preferably 2.0-7.0, more preferably 2.0-4.0.

The control of O/Si ratios for decreasing hydroxyl content as integrated with the technological characteristics of PCVD, has two functions. Firstly, properly decreasing O/Si ratio leads to a decrease in the number of peroxy-bonds in glass and thus a decrease in the opportunity of formation of hydroxyl groups; secondly, reaction equation (2) shows that the reaction of raw materials produces a large quantity of chlorine gas which can capture moisture to produce HCl, which is easy to discharge. The decrease in O/Si ratio correspondingly increases the concentration of chlorine and thus the capacity of chorine to capture moisture. In addition, the increase in chlorine content enhances the refractivity of glass, reduces the amount of germanium as a dopant, and reduces Rayleigh scattering of glass, decreasing the intrinsic attenuation. O/Si ratio is controlled to be 1.5-3.0 in the present invention.

As described above, PCVD technology is to be performed in a hermetic container under negative pressure, therefore, the gastightness of system is very important. In the present invention, in addition to the gastightness of pipes 1 and 9, the gastightness of the sealed rotating gripping head 2 must be especially secured to prevent moisture outside from coming into the system. The dynamic leak ratio of deposition machine must be 1.0×10⁻⁵ mbar·l/s or less, preferably 1.0×10⁻⁷ mbar·l/s or less, more preferably 1.0×10⁻⁹ mbar·l/s or less. The dynamic leak rate of melt contraction machine must be 1.0×10⁻⁵ mbar·l/s or less, preferably 1.0×10⁻⁷ mbar·l/s or less, more preferably 1.0×10⁻⁹ mbar·l/s or less.

In the present invention, the environment condition is strictly controlled to further reduce the effect of outside moisture on the quality of the optical fiber and the optical fiber preform rod. Besides using “non-water” heat source, the deposition and melt contraction processes are carried out in “non-water” environment. Such an environment is typically provided by dry air, the relative humidity of which at 25° C. is less than 25%, preferably 15% or less, more preferably 5% or less, most preferably 0%. The environment temperature is controlled at 15-30° C. Such an environment is provided by dry air as well as dry nitrogen, argon, helium, or carbon dioxide or combinations thereof.

Moreover, all possible operations in the whole technological process are also carried out in an “non-water” environment, including the transfer of the substrate tube from the deposition machine to the melt contraction machine, the RIT process of combination of the core rod and the jacket tube, and the process of sending the optical fiber preform into the fiber drawing furnace. The “non-water” environment can be provided by one or more dry gases selected from air, nitrogen, argon, helium and carbon dioxide, etc.

In the present invention, a method favorable for reducing the hydroxyl content in the preform rod is also proposed. A core rod of larger diameter is prepared, and a jacket tube is used to combine with it or an outer cladding is OVD deposited onto it, thus making a preform for direct fiber drawing; alternatively, the preform rod of larger diameter is drawn into a preform of smaller diameter for subsequent fiber drawing.

This drawing method is based on a “dilution” principle proposed by us. For raw materials of given purity, the amount of moisture introduced from outside depends on the size of various interfaces in the substrate tube (between the inner surface of the substrate tube and the deposited layer, between the deposited layer and the atmosphere), but its relationship with processing time is not evident. During PCVD, a core rod of larger diameter can be prepared using the same substrate tube, and, therefore, has almost the same absorption of moisture, but the water (i.e., hydroxyl groups) content per unit volume of the core rod of larger diameter is less than the hydroxyl contents of the core rod of smaller diameter directly prepared by PCVD.

From this principle two approaches for reducing hydroxyl content are derived. One approach is to form a core rod of larger diameter (>20 mm) by melt contraction, draw it into a core rod of smaller diameter (≦20 mm), then accomplish the preparation of preform rod by using a jacket tube or OVD technology. The other approach is to draw a preform rod of larger diameter (>100 mm) into a preform rod of smaller diameter (<80 mm) followed by direct fiber drawing. Heat source for drawing employed may either be an electroheating apparatus or a plasma generating apparatus. In our published Chinese Patent Application CN1396131A, the process of drawing larger diameter core rod prepared by PCVD into smaller diameter core rod is described. By optimizing PCVD technology, the control of the core rod parameter can reduce the water peak at 1383 nm to some degree, at the same time increase the efficiency of optical fiber manufacture and reduce the cost of production.

From the above it is clear that the present invention has made a lot of improvements and innovations to traditional PCVD technology and has made low water peak single mode optical fiber by PCVD for the first time. The complete process of the present invention is the following: the high purity raw material gas containing, for example, SiCl₄, GeCl₄, O₂ and C₂F₆ in appropriate proportion is passed through a well sealed pipe and a well sealed rotating gripping head into a substrate tube of low hydroxyl content under appropriate environmental condition, and the reactant gases are activated under the action of microwave to react and deposit a layer of certain construction design on the inner wall of the substrate tube.

Deuterium can be introduced prior to, after, or during deposition to further eliminate the effect of possible presence of hydroxyl groups.

The substrate tube after deposition continues to undergo melt contraction under appropriate environmental condition. Here, electroheating apparatus is used as heat source, process gases, for example, C₂F₆ and O₂ are passed through a well sealed pipe and a well sealed rotating gripping head into a substrate tube, and then the substrate tube is melt contracted into a solid core rod according the melt contraction technology. In order to eliminate the effect of possible presence of hydroxyl groups, D₂ or Cl₂ is introduced for treatment during melt contraction process. The core rod is corroded with hydrofluoric acid (HF) to remove hydroxyl-rich portion of glass on the surface of the core rod.

The core rod and a jacket tube of low hydroxyl content are combined into an optical fiber preform using RIT technology, or on the outer surface of the core rod an outer cladding is deposited using OVD method to produce an optical fiber preform. The obtained optical fiber preform is sent through a conveying mechanism into a fiber drawing furnace to be drawn into optical fiber.

The advantages of the present invention are as follows.

1. The attenuation of the optical fiber manufactured by the method provided by the present invention is less than 0.344 dB/km at 1310 nm, less than 0.334 dB/km at 1383 nm, less than 0.224 dB/km at 1550 nm. The attenuation at 1383 nm is lower than the stipulated value at 1310 nm. According to the method of hydrogen loss measurement provided by IEC, the optical fiber is placed in an atmosphere with its H₂ partial pressure being 0.01 atm at room temperature, and the attenuation increase of the optical fiber at 1240 nm is continuously monitored. When the attenuation increases beyond 0.03 dB/km at 1240 nm, the optical fiber is removed from the atmosphere. Its attenuation at 1383 nm is determined under normal condition after 14 days. The increase in attenuation of the optical fiber of the present invention does not exceed 0.01 dB/km.

2. The manufacture method provided by the present invention makes full use of the advantages of PCVD technology. It can produce low water peak optical fiber at low cost which meets ITU-T G652.C Standard. It is especially suitable for large scale production.

3. Making use of the unique performance of PCVD technology and optimizing this technology can also effectively prevent outside hydroxyl groups from attacking the core layer and maintain the core layer at a low hydroxyl state.

### EXAMPLES

### Example 1

In an “non-water” environment of dry air (relative humidity, 0%, temperature, 25° C.), highly pure raw materials SiCl₄, GeCl₄, C₂F₆ and O₂ (wherein the infrared transmissivity of impurities SiCl₃OH and GeCl₃OH are 99.9%, water content of C₂F₆ is 8 ppb, water content of O₂ is 0.9 ppb), are introduced into a substrate tube of hydroxyl content of 9 ppb, and deposition is carried out by PCVD described above in a deposition machine with the dynamic leak rate of 1.0×10⁻⁹ mbar·l/s. The controlled b/a value is 4.0, the refractivity contribution of freon doped in a cladding is −0.15%, the value of Δ− of the cladding doped with freon and germanium is −0.02%, the refractivity contribution of freon doped in a core layer is −0.07%, the value of Δ+ of the core layer doped with freon and germanium is 0.33%.

In the environment of the same humidity and temperature, the substrate tube is melt contracted with a graphite electroheating furnace in a melt contraction machine whose dynamic leak rate is 1.0×10⁻⁹ mbar·l/s. The core rod melt contracted has a diameter of 20 mm. It is combined with a jacket tube of hydroxyl content of 80 ppb and is directly subjected to fiber drawing.

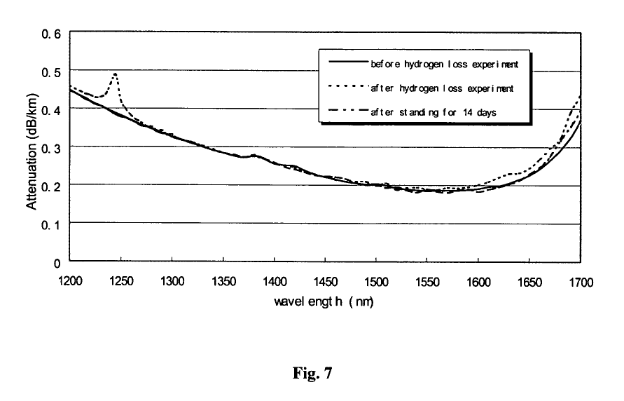

The optical fiber has a water peak value of 0.273 dB/km at 1383 nm, and its attenuation at 1383 nm measured after hydrogen loss experiment is 0.278 dB/km, as shown in FIG. 7. Other parameters meet the requirement of G.652.C standard for optical fiber.

### Example 2

Using a procedure similar to that in Example 1, in this case, in an “non-water” environment of dry air (relative humidity, 5%, temperature, 23° C.), highly pure raw materials SiCl₄, GeCl₄, C₂F₆ and O₂ (wherein the infrared transmissivity of impurity SiCl₂OH is 96% and that of impurity GeCl₃OH is 98%, water content of C₂F₆ is 50 ppb, water content of O₂ is 8 ppb) are introduced into a substrate tube of hydroxyl content of 85 ppb for deposition. During deposition a mixed gas containing deuterium (1% D₂+99% He) is introduced. Under the condition that the dynamic leak rate of the deposition machine is 1.0×10⁻⁷ mbar·l/s, control the deposition process performs under the conditions of b/a value equals 7.0. The refractivity contribution of freon doped in the cladding is −0.20%, the value of Δ− of the cladding doped with freon and germanium is −0.03%, the refractivity contribution of freon doped in the core layer is −0.20%, the value of Δ+ of the core layer doped with freon and germanium is 0.32%.

In the environment of the same humidity and temperature, the substrate tube is melt contracted with a graphite electroheating furnace in a melt contraction machine with a dynamic leak rate of 1.0×10⁻⁷ mbar·l/s. The core rod melt contracted has a diameter of 30 mm. It is drawn into smaller core rods with a diameter of 18 mm. The core rod is combined with a jacket tube of hydroxyl content of 450 ppb, then melt contracted to form a solid optical fiber preform, and finally drawn into optical fiber.

The optical fiber has a water peak value of 0.297 dB/km at 1383 nm, and its attenuation at 1383 nm measured after hydrogen loss experiment is 0.300 dB/km. Other parameters meet the requirement of G.652.C Standard for optical fiber.

### Example 3

A procedure similar to that of the previous two examples is used. In the raw materials SiCl₄, GeCl₄, C₂F₆ and O₂, the infrared transmissivity of impurity SiCl₃OH is 92%, that of GeCl₃OH is 94%, water content of C₂F₆ is 200 ppb, water content of O₂ is 75 ppb. Hydroxyl content of the substrate tube is 600 ppb. Hydroxyl content of the jacket tube is 5 ppm. Deposition is performed by the above described PCVD technology, whose b/a value is 2.0. The refractivity contribution of freon doped in the cladding is −0.05%, the value of Δ− of the cladding doped with freon and germanium is 0.01%, the refractivity contribution of freon doped in the core layer is −0.05%, the value of Δ+ of the core layer doped with freon and germanium is 0.40%.

The dynamic leak rate of the deposition machine used is 1.0×10⁻⁵ mbar−l/s. The dynamic leak rate of melt contraction machine used is 1.0×10⁻⁵ mbar·l/s. The environment provided by dry air has a relative humidity of 25% and a temperature of 25° C.

The diameter of the core rod produced is 22 mm. The required SiO₂ soot is deposited on the surface of the core rod using OVD technology. Chlorine gas is introduced during sintering for removing water. The optical fiber preform thus obtained is subjected to fiber drawing.

The optical fiber has a water peak value of 0.331 dB/km at 1383 nm, and its attenuation at 1383nm measured after hydrogen loss experiment is 0.336 dB/km. Other parameters meet the requirement of G.652.C Standard for optical fiber.

In addition, the method provided by the present invention is not limited to the manufacture of G652.C optical fiber. Any single mode optical fiber can be produced with this method. And water peak of fiber can be effectively reduced or even eliminated.

1. A method of manufacturing low water peak single mode optical fiber, which comprises performing deposition in a substrate tube using PCVD technology, whereby a deposited layer of a certain construction design is formed on the inner wall of the substrate tube, melt contracting the substrate tube into a solid core rod according to melt contraction technology, making an optical fiber preform by combining the core rod and a jacket tube of low hydroxyl content by means of RIT technology or by depositing an outer cladding on the outer surface of the core rod using OVD technology, sending the optical fiber preform into a fiber drawing furnace to draw it into an optical fiber, wherein:
in the PCVD technology, the content of impurities in a gas mixture of raw materials, which is characterized by the infrared spectrum transmissivity thereof, is required to be a transmissivity of 90% or greater, the water content in O₂ is 100 ppb or less, the water content in C₂F₆ is 1000 ppb or less, the hydroxyl content of the substrate tube is 1000 ppb or less, the dynamic leak rate of a deposition machine is b 1.0×10⁻⁵ mbar·l/s or less;
during melt contraction of the substrate tube, the dynamic leak rate of a melt contraction machine is 1.0×10⁻⁵ mbar·l/s or less;
the hydroxyl content of the jacket tube of low hydroxyl content is required to be 10 ppm or less;
the relative humidity of environment during the process of manufacture is 25% or less;
the ratio of the cladding diameter to the core layer diameter (b/a value) in the waveguide structure of the optical fiber is from 2.0 to 7.0.

2. The method according to claim 1, wherein the gas mixture of raw materials taking part in reaction during the PCVD technology comprises one or more silicon raw materials, GeCl₄, C₂F₆, and O₂, and the silicon raw materials are selected from the group consisting of SiCl₄, SiF₄, SiO, Si₃N₄, SiBr₄, and (SiO₂).Si(NCO)₄.

3. The method according to claim 2, wherein the content of impurity SiCl₃OH in SiCl₄, which is characterized by the infrared transmissivity thereof, is required to be a transmissivity from 90% to 100%; the content of impurity GeCl₃OH in GeCl₄, which is characterized by the infrared transmissivity thereof, is required to be a transmissivity from 90% to 100%.

4. The method according to claim 1, wherein the water content in O₂ is 10 ppb or less; the water content in C₂F₆ is less than 100 ppb; the hydroxyl content of the substrate tube is 100 ppb or less; the hydroxyl content of the jacket tube of low hydroxyl content is 1 ppm or less.

5. The method according to claim 2, wherein the ratio of oxygen to silicon (O/Si value) in the gas mixture of raw materials is in the range of from 1.5 to 3.0.

6. The method according to claim 1, wherein the refractivity contribution of freon doped in the cladding is −0.05% to −0.20%; Δ− of the cladding doped with F/Ge is −0.03%˜0.01 %; the refractivity contribution of freon doped in the core layer is −0.05% to −0.20%; Δ+ of the core layer doped with F/Ge is 0.30% to 0.40%.

7. The method according to claim 1, wherein the ratio of the cladding diameter to the core layer diameter is from 2.0 to 4.0.

8. The method according to claim 1, wherein the dynamic leak rate of the deposition machine is 1.0×10⁻⁷ mbar·l/s or less; the dynamic leak rate of the melt contraction machine is 1.0×10⁻⁷ mbar·l/s or less.

9. The method according to claim 1, wherein the temperature of environment during the process of manufacture is controlled in the range of 15° C. to 30° C.; the relative humidity of the environment at 25° C. is 15% or less.

10. The method according to claim 9, wherein during the process of manufacture, the environment contains a dry gas selected from the group of nitrogen, argon, helium, or carbon dioxide, or the combinations thereof.

11. The method according to claim 1, wherein a mixed gas containing deuterium is introduced for treating the substrate tube prior to the beginning of the deposition and/or after the deposition is finished; and/or a mixed gas containing deuterium is introduced into the substrate tube to take part in the reaction during the deposition; and/or a mixed gas containing deuterium is introduced for treating the substrate tube during the melt contraction.

12. The method according to claim 11, wherein the mixed gas containing deuterium also contains one or more gas of helium, argon and nitrogen.

13. The method according to claim 11, wherein the mixed gas containing deuterium contains 1-100% deuterium.

14. The method according to claim 11, wherein the time of treatment is from 10 minutes to 10 hours; the temperature of treatment is from 500° C. to 1100° C.

15. The method according to claim 1, wherein Cl₂ gas is introduced during the melt contraction to treat the substrate tube synchronously.

16. The method according to claim 1, wherein a graphite electroheating furnace or a plasma is used as heat source during the melt contraction; the core rod melt contracted is corroded with hydrofluoric acid, to a depth from 0.1 mm to 1.0 mm.

17. The method according to claim 1, wherein an oxyhydrogen flame torch is used as heat source during the melt contraction; the core rod melt contracted is corroded with hydrofluoric acid, to a depth from 0.5 mm to 1.5 mm.

18. The method according to claim 1, wherein during the melt contraction, when the diameter of the central hole is contracted to an appropriate size, a mixed gas consisting of O₂ and C₂F₆ is introduced to corrode the central hole, and the depth of the deposited layer corroded away is controlled with the range 0.05-0.20 mm.

19. The method according to claim 1, wherein the melt contracted core rod of diameter larger than 20 mm is drawn into a core rod of diameter of 20 mm or less, followed by using the jacket tube or OVD technology to complete the manufacture of the optical fiber preform.

20. The method according to claim 1, wherein the preform of diameter larger than 100 mm is drawn into a preform of diameter smaller than 80 mm, followed by direct fiber drawing.
